(19) United States
(12) Patent Application Publication
(10) Pub. No.: US 2026/0281979 A1
(43) Pub. Date: Sep. 17, 2026

(54) METHOD AND APPARATUS FOR DETERMINING RESOURCE STATE, AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/167,064

(22) PCT Filed: Mar. 22, 2023
(86) PCT No.: PCT/CN2023/083217

§ 371 Date: Sep. 19, 2025

(51) Int. Cl. H04W 72/044

(52) U.S. Cl. CPC H04W 72/044

(57) ABSTRACT

Provided in the embodiments of the present disclosure are a method and apparatus for determining a resource state, and a storage medium. The method comprises: a terminal device sending a first message to a network device, wherein the first message may comprise a first parameter field, the first parameter field may be used for indicating a resource usage state of a first radio resource, and the first radio resource is a radio resource corresponding to a plurality of configured grant (CG) configurations. In this way, a terminal device can report a resource usage state of a first radio resource to a network device, such that the network device flexibly uses and schedules the first radio resource according to the resource usage state.

### CROSS REFERENCE TO RELATED APPLICATION

The present application is a U.S. National Stage of International Application No. PCT/CN2023/083217, filed on Mar. 22, 2023, the entire contents of which are incorporated herein by reference.

### BACKGROUND OF THE INVENTION

In wireless communication systems, in order to reduce the uplink service latency, the Configured Grant (CG) transmission manner is introduced into the 3rd Generation Partnership Project (3GPP). The CG transmission manner may also be referred to as an uplink grant-free transmission manner. By the CG transmission manner, a network device may pre-configure one or more CG configurations for a terminal, and the terminal may autonomously use wireless resources associated with the CG configurations for uplink transmission without scheduling of the network device. Thus, scheduling resources may be saved, and the uplink service latency may be reduced.

### SUMMARY OF THE INVENTION

According to a first aspect of the embodiments of the present disclosure, a method for determining a resource state is provided, and the method is performed by a terminal. The method includes: sending a first message to a network device, where the first message includes a first parameter field, the first parameter field is configured to indicate resource usage states of first wireless resources, and the first wireless resources are wireless resources corresponding to a plurality of CG configurations.

According to a second aspect of the embodiments of the present disclosure, a method for determining a resource state is provided, and the method is performed by a network device. The method includes: receiving a first message sent by a terminal, where the first message includes a first parameter field, the first parameter field is configured to indicate resource usage states of first wireless resources, and the first wireless resources are wireless resources corresponding to a plurality of CG configurations; and determining the resource usage states of the first wireless resources according to the first parameter field in the first message.

According to a third aspect of the embodiments of the present disclosure, a device for determining a resource state is provided. The device includes a processor and a memory configured to store instructions executable by the processor. The processor is configured to: send a first message to a network device, where the first message includes a first parameter field, the first parameter field is configured to indicate resource usage states of first wireless resources, and the first wireless resources are wireless resources corresponding to a plurality of CG configurations.

According to a fourth aspect of the embodiments of the present disclosure, a device for determining a resource state is provided. The device includes a processor and a memory configured to store instructions executable by the processor. The processor is configured to perform steps of the method for determining the resource state provided by the second aspect of the present disclosure.

### BRIEF DESCRIPTION OF DRAWINGS

The accompanying drawings here are incorporated into the specification and constitute a part of the specification, illustrate principles conforming to the embodiments of the present disclosure, and are used to explain the present disclosure together with the specification.

FIG. 1 is a schematic diagram of a communication system according to an example.

FIG. 2 is a schematic diagram of a plurality of CG configurations according to an example.

FIG. 3 is a flowchart of a method for determining a resource state according to an example.

FIG. 4 is a schematic diagram of a plurality of CG configurations and a first parameter field according to an example.

FIG. 5 is a schematic diagram of a plurality of CG configurations and a first parameter field according to another example.

FIG. 6 is a flowchart of a method for determining a resource state according to an example.

FIG. 7 is a flowchart of a method for determining a resource state according to an example.

FIG. 8 is a block diagram of a terminal according to an example.

FIG. 9 is a block diagram of a terminal according to an example.

FIG. 10 is a block diagram of a network device according to an example.

FIG. 11 is a block diagram of a device for determining a resource state according to an example.

### DETAILED DESCRIPTION OF THE INVENTION

The examples are described in detail here, as illustrated in the accompanying drawings. When the following description refers to the accompanying drawings, the same numerals in different accompanying drawings represent the same or similar elements, unless otherwise indicated. The implementations described in the following examples do not represent all implementations consistent with the present disclosure. Instead, the implementations are merely examples of devices and methods consistent with some aspects of the present disclosure as detailed in the appended claims.

In the description of the embodiments of the present disclosure, terms such as “first” and “second” as used are configured to distinguish similar objects and do not need to be understood as indicating a particular order or sequence. Additionally, in the description with reference to the accompanying drawings, the same numerals in different accompanying drawings denote the same elements in case of no contrary indication.

In the description of the embodiments of the present disclosure, “a plurality of” means two or more, and other quantifiers are similar, unless otherwise specified. “At least one,” “one or more,” or similar expressions refer to any combination of these items, including any combination of single or multiple items. For example, “at least one” may represent any number. For another example, “one or more of a, b, and c” may represent a, b, c, a-b, a-c, b-c, or a-b-c, where a, b and c may be singular or plural. “And/or” describes an associative relationship between associated objects, representing three possible relationships. For example, “A and/or B” may represent three cases: A exists alone, A and B exist simultaneously, or B exists alone, where A and B may be singular or plural. The character “/” represents an “or” relationship between the associated objects before and after it. Singular forms “one,” “a,” “an,” “said,” “the,” “aforementioned,” and “foregoing” are also intended to include plural forms, unless the context clearly indicates otherwise.

In the description of the embodiments of the present disclosure, expressions such as “A in a case, and B in another case” and “A in response to a case, and B in response to another case” may include the following technical solutions according to situations. A is performed regardless of B, meaning that in some embodiments, A is performed; B is performed regardless of A, meaning that in some embodiments, B is performed; A or B is selectively performed, meaning that in some embodiments, A or B is selected to be performed; and both A and B are performed, meaning that in some embodiments, A and B are performed. Similar logic applies when there are more branches such as A, B and C.

In the description of the embodiments of the present disclosure, expressions such as “including A,” “containing A,” “configured to indicate A,” or “carrying A” may be interpreted as directly carrying A, or indirectly indicating A.

In the description of the embodiments of the present disclosure, expressions such as “in response to . . . ,” “in response to determining . . . ,” “under the condition that . . . ,” “when . . . ,” “upon . . . ,” “in a case of . . . ,” and “in a case where . . .” are interchangeable.

In some embodiments, terms such as “greater than,” “greater than or equal to,” “above,” “higher than,” and “not less than” are interchangeable. Terms such as “less than,” “less than or equal to,” “below,” “lower than,” and “not greater than” are interchangeable.

In some embodiments, terms such as “network element,” “node,” “function,” “device,” “equipment,” “system,” “chip,” and “system on chip” are interchangeable.

Additionally, each element, row or column in a table in the embodiments of the present disclosure may be implemented as an independent embodiment. A combination of any element, row or column may also be implemented as an independent embodiment.

Although operations or steps are described in a particular order in the embodiments or accompanying drawings of the present disclosure, this is not to be understood as requiring that these operations or steps be performed in the particular order as illustrated or in a sequential manner, or that all of the illustrated operations or steps be performed to achieve a desired result. In the embodiments of the present disclosure, in case of no contradiction, these operations or steps may be performed in any order or performed in parallel, or part of these operations or steps may be performed, or operations or steps in a plurality of embodiments or accompanying drawings may be combined arbitrarily, which are not limited in the embodiments of the present disclosure.

It is to be noted that the embodiments of the present disclosure are not exhaustive and are merely illustrative of some embodiments, which are not construed as specific limitations to the scope of protection of the present disclosure. In case of no contradiction, each step in a certain embodiment may be implemented as an independent embodiment, and the steps may be combined arbitrarily. For example, a solution in which part of the steps are removed from a certain embodiment may still be implemented as an independent embodiment. Further, the order of the steps in a certain embodiment may be arbitrarily rearranged. Additionally, implementations of a certain embodiment may be combined arbitrarily. Moreover, various embodiments may be combined arbitrarily. For example, part or all of the steps in different embodiments may be combined arbitrarily, and a certain embodiment may be combined arbitrarily with implementations of other embodiments.

In the following, an implementation environment of the embodiments of the present disclosure is first introduced.

The technical solutions of the embodiments of the present disclosure are applicable to various communication systems. The communication systems may include one or more of the 4th Generation (4G) communication system, the 5th Generation (5G) communication system, and other future wireless communication systems such as 6G. The communication systems may further include one or more of a Public Land Mobile Network (PLMN), a Device-to-Device (D2D) communication system, a Machine to Machine (M2M) communication network, an Internet of Things (IoT) communication system, a Vehicle-to-Everything (V2X) communication system, or other communication systems.

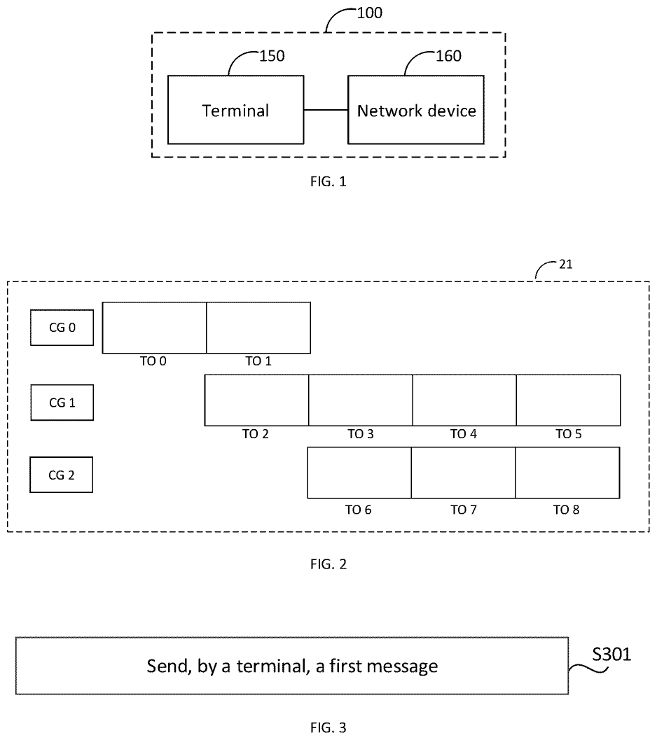

FIG. 1 is a schematic diagram of a communication system 100 according to an example. As shown in FIG. 1, the communication system 100 may include a terminal 150 and a network device 160. The communication system may be configured to support a 4G network access technology such as a Long Term Evolution (LTE) access technology, or a 5G network access technology such as a New Radio Access Technology (New RAT), or other future wireless communication technologies. It is to be noted that in the communication system, each of the number of the network device and the number of the terminal may be either one or more. The number of network devices and terminals in the communication system shown in FIG. 1 is merely an illustrative example and is not limited in the present disclosure.

The network device 160 in FIG. 1 may be configured to provide a wireless communication function for the terminal. For example, the network device may include an evolutional Node B (eNB or eNodeB) in the LTE. The network device may further include the next Generation Node B (gNB or gNodeB) in a 5G network. The network device may further include an NG-Radio Access Network (NG-RAN) device in the 5G network. The network device may further include at least one of a base station in a future evolved Public Land Mobile Network (PLMN), a Broadband Network Gateway (BNG), an aggregation switch, or a non-3GPP access device. In some examples, the network device in the embodiments of the present disclosure may include at least one of the following types of base stations, such as a macro base station, a micro base station (also referred to as a small station), a relay station, an access point, a 5G base station or future base station, a satellite, a Transmitting and Receiving Point (TRP), a Transmitting Point (TP), a mobile switching center, and Device-to-Device (D2D), Machine-to-Machine (M2M), Internet of Things (IoT), Vehicle-to-Everything (V2X) or other devices functioning as a base station in the communication system, which are not limited in the present disclosure. For convenience of description, in the embodiments of the present disclosure, a device providing a wireless communication function for the terminal may be referred to as the network device.

In some embodiments, the network device 160 may include a core network device and an access network device, and the access network device may also be referred to as a base station.

The terminal 150 in FIG. 1 may be an electronic device providing voice or data connectivity. For example, the terminal may also be referred to as User Equipment (UE), a Subscriber Unit, a Mobile Station, a Station, a Terminal and so on. For example, the terminal may include a smart phone, a smart wearable device, a smart speaker, a smart tablet, a wireless modem, a Wireless Local Loop (WLL) station, a Personal Digital Assistant (PDA), Customer Premise Equipment (CPE) and so on. With the development of wireless communication technology, a device capable of accessing the communication system, communicating with the network device of the communication system, or communicating with other objects via the communication system, or two or more devices capable of communicating directly may all be the terminal in the embodiments of the present disclosure, for example, terminals and vehicles in smart traffic, household appliances in smart home, power metering instruments in smart grid, voltage monitoring instruments, environmental monitoring instruments, video monitoring instruments in smart security network, and cash registers. In the embodiments of the present disclosure, the terminal may communicate with the network device, and a plurality of terminals may also communicate with each other. The terminal may be stationary or mobile, which is not limited in the embodiments of the present disclosure.

In some embodiments of the present disclosure, both of the terminal 150 and network device 160 may support a CG transmission manner, which may also be referred to as an uplink grant-free transmission manner.

For example, the network device 160 may configure one or more CG configurations for the terminal based on the CG transmission manner. Each CG configuration may include one or more first wireless resources, and the terminal may autonomously use the first wireless resource for uplink transmission without scheduling of the network device. Thus, scheduling resources may be saved, and uplink service latency may be reduced. The first wireless resource may also be referred to as a CG Physical Uplink Shared Channel (PUSCH) Transmission Resource (TR) (CG PUSCH TR) or a CG PUSCH Transmission Occasion (TO) (CG PUSCH TO), or may be simply referred to as a CG PUSCH Occasion, a CG TO, or a TO.

In some embodiments, each CG configuration may correspond to one CG period, and the CG configuration may take effect within the CG period. The number of symbols corresponding to one CG period may be determined by the network device and sent to the terminal. For example, the network device may send the number of symbols to the terminal via higher-layer signaling (such as RRC signaling). In an implementation, one CG period may correspond to up to 14*40,960 symbols.

In some embodiments, the network device may allocate a plurality of CG configurations to the terminal. Different CG configurations may have the same or different frequency-domain positions, and similarly, different CG configurations may have the same or different time-domain positions. For example, different CG configurations may have the same frequency-domain positions but different time-domain positions. For another example, different CG configurations may have different frequency-domain positions but the same time-domain positions. For another example, different CG configurations may have different frequency-domain positions and different time-domain positions.

In some embodiments, the network device may allocate one CG configuration to the terminal.

In some other embodiments, the network device may allocate a plurality of CG configurations to the terminal, such as 2 CG configurations or 16 CG configurations.

It is to be noted that different CG configurations may have the same or different frequency-domain positions, and similarly, different CG configurations may have the same or different time-domain positions.

For example, frequency-domain positions of different CG configurations may be completely the same, completely different, or partially the same. For example, frequency-domain positions of part of the CG configurations may overlap.

For another example, time-domain positions of different CG configurations may also be completely the same, completely different, or partially the same. For example, time-domain positions of part of the CG configurations may overlap.

For another example, different CG configurations may have the same frequency-domain positions but different time-domain positions.

For another example, different CG configurations may have different frequency-domain positions but the same time-domain positions.

For another example, different CG configurations may have different frequency-domain positions and different time-domain positions.

In some embodiments, each CG configuration may include a plurality of first wireless resources, and the first wireless resources may be wireless resources allocated by the network device to the terminal based on one or more CG configurations. The first wireless resources may also be referred to as CG PUSCH TRs or CG PUSCH TOs, or may be simply referred to as CG PUSCH Occasions, CG TOs, or TOs. The numbers of first wireless resources included in different CG configurations may be the same or different.

FIG. 2 is a schematic diagram of a plurality of CG configurations according to an example. As shown in FIG. 2, the network device may allocate a plurality of CG configurations 21 (such as three) to the terminal. The plurality of CG configurations 21 may include CG0, CG1, and CG2, and each CG configuration may include a plurality of first wireless resources. For example, first wireless resources included in CG0 may be TO0 and TO1, first wireless resources included in CG1 may be TO2, TO3, TO4, and TO5, and first wireless resources included in CG2 may be TO6, TO7, and TO8. It is to be noted that although FIG. 2 takes a case where the number of first wireless resources included in each CG configuration is different for example, it is to be understood that the number of first wireless resources included in each CG configuration may also be the same, which is not limited in the embodiments of the present disclosure.

In the embodiments of the present disclosure, the network device may allocate a CG configuration to the terminal in various manners.

For example, in some embodiments, the network device may send all information of the CG configuration to the terminal via a second message (such as RRC signaling or other messages), and the terminal autonomously uses the CG configuration for uplink transmission after receiving the second message sent by the network device. The second message may carry all information of one or more CG configurations.

In some other embodiments, the network device may send all information of the CG configuration to the terminal via a second message (such as RRC signaling or other messages), and activate the CG configuration via a third message (such as activation DCI indication, a MAC CE or other messages), and the terminal may autonomously use the CG configuration for uplink transmission after receiving the second message and the third message.

In some other embodiments, the network device may send part of information of the CG configuration to the terminal via a second message (such as RRC signaling or other messages), send the other part of the information of the CG configuration to the terminal and activate the CG configuration via a third message (such as activation DCI indication, an MAC CE or other messages), to complete all information of the CG configuration, and the terminal may autonomously use the CG configuration for uplink transmission after receiving the second message and the third message.

In the related art, management and scheduling of wireless resources based on the CG transmission manner is relatively simple and is not applicable to demands of new services. For example, the above communication system may also support XR (such as Augmented Reality (AR) and/or Virtual Reality (VR)) service. Different from three existing typical services, i.e., Ultra-Reliable Low-Latency Communications (URLLC), enhanced Mobile Broadband (eMBB), and enhanced Machine-Type Communication (eMTC), the XR service is characterized by periodicity, high throughput demands and short latency.

Moreover, the XR service has certain flexibility, and wireless resources needed for transmission may not match the first wireless resources allocated by the network device based on the CG transmission manner. For example, part of the first wireless resources may be idle, or part of time-domain symbols of the first wireless resources may be idle, which leads to a low utilization rate of the wireless resources allocated based on the CG transmission manner. In particular, in a scenario where the network device configures a plurality of CG configurations for the terminal, how to indicate resource usage states of the plurality of CG configurations has become an urgent problem to be solved.

FIG. 3 is a flowchart of a method for determining a resource state according to an example. As shown in FIG. 3, the method may be performed by a terminal in the above communication system. The method may include step S301.

In step S301, the terminal sends a first message.

For example, the terminal may send the first message to a network device.

In some embodiments, the first message may include a first parameter field, and the first parameter field may be configured to indicate resource usage states of first wireless resources.

In an implementation, the first wireless resources may be wireless resources allocated by the network device to the terminal based on one or more CG configurations.

In another implementation, the first wireless resources may be wireless resources corresponding to a plurality of CG configurations, and the CG configurations may be wireless resources allocated by the network device to the terminal based on a CG configuration manner.

In some embodiments, the resource usage state may be an idle state or an occupied state.

It is to be noted that the network device may allocate a plurality of CG configurations to the terminal, and the first wireless resources may be all or part of CG transmission occasions included in the plurality of CG configurations.

In some embodiments, the plurality of CG configurations allocated by the network device to the terminal may be a plurality of CG configurations having the same frequency-domain configurations but different time-domain configurations, a plurality of CG configurations having different frequency-domain configurations and different time-domain configurations, or a plurality of CG configurations having different frequency-domain configurations but the same time-domain configurations.

In some embodiments, different CG configurations may have the same or different frequency-domain positions, and similarly, different CG configurations may have the same or different time-domain positions. For example, different CG configurations may have the same frequency-domain positions but different time-domain positions. For another example, different CG configurations may have different frequency-domain positions but the same time-domain positions. For another example, different CG configurations may have different frequency-domain positions and different time-domain positions.

In this way, the terminal may report the resource usage states of the first wireless resources to the network device, such that the network device may flexibly use and schedule the first wireless resources according to the resource usage states, which improves the utilization rate of the wireless resources allocated based on the CG transmission manner.

In some other embodiments, the first message may include a second parameter field and the above first parameter field. The second parameter field may be configured to indicate the number M of first wireless resources in a first CG configuration, and the first CG configuration is a CG configuration having the maximum number of first wireless resources among the plurality of CG configurations.

For example, the first wireless resources may be CG transmission occasions, the second parameter field may be configured to indicate the number of CG transmission occasions in the first CG configuration, and the first CG configuration is a CG configuration having the maximum number of CG transmission occasions among the plurality of CG configurations.

In this way, the terminal may indicate, via the first message, the maximum value of the number of first wireless resources in the plurality of CG configurations and the resource usage states of the first wireless resources.

In some other embodiments, the first message includes the above first parameter field. The terminal may determine the above second parameter field when obtaining the CG configurations according to a second message or a third message sent by the network device. That is, the number M of the first wireless resources in the first CG configuration is determined. The first CG configuration is a CG configuration having the maximum number of first wireless resources among the plurality of CG configurations.

Similarly, the network device may also determine the second parameter field when allocating the CG configurations to the terminal.

For example, the first wireless resources may be CG transmission occasions, the second parameter field may be configured to indicate the number of CG transmission occasions in the first CG configuration, and the first CG configuration is a CG configuration having the maximum number of CG transmission occasions among the plurality of CG configurations.

In this way, the terminal may indicate, via the first message, the resource usage states of the first wireless resources.

In some other embodiments, the first message may include a third parameter field and the above first parameter field, and the third parameter field may be configured to indicate the number N of the CG configurations.

It is to be noted that the number N of the CG configurations indicated by the third parameter field may be equal to or less than the number of all CG configurations allocated by the network device to the terminal.

For example, the network device allocates A CG configurations to the terminal, and the number N of the CG configurations indicated by the third parameter field may be equal to or less than A. The first parameter field may indicate resource usage states of first wireless resources included in N CG configurations.

In this way, the terminal may indicate, via the first message, the number of the CG configurations and the resource usage states of the first wireless resources.

In some other embodiments, the first message may include the above first parameter field. The terminal may determine the above third parameter field when obtaining the CG configurations according to the second message or the third message sent by the network device. In other words, the number N of the CG configurations is determined.

Similarly, the network device may also determine the third parameter field when allocating the CG configurations to the terminal.

It is to be noted that the number N of the CG configurations indicated by the third parameter field may be equal to or less than the number of all CG configurations allocated by the network device to the terminal.

For example, the network device allocates A CG configurations to the terminal, and the number N of the CG configurations indicated by the third parameter field may be equal to or less than A. The first parameter field may indicate resource usage states of first wireless resources included in N CG configurations.

In this way, the terminal may indicate, via the first message, the resource usage states of the first wireless resources.

In some other embodiments, the first message may include the above first parameter field, the second parameter field, and the third parameter field.

In this way, the terminal may indicate, via the first message, the number of the CG configurations, the maximum value of the number of first wireless resources in the plurality of CG configurations, and the resource usage states of the first wireless resources.

In some embodiments of the present disclosure, the terminal may send the first message to the network device via a third wireless resource. Similarly, the network device may also receive the first message via the third wireless resource.

In an implementation, the third wireless resource may be a wireless resource determined according to agreement in a protocol.

In another implementation, the third wireless resource may be a wireless resource determined by the network device, and the network device may further send information of the third wireless resource to the terminal.

In another implementation, the third wireless resource may be a wireless resource determined by the terminal, and the terminal may further send information of the third wireless resource to the network device.

It is to be noted that the third wireless resource may simply carry the first message, or may carry both the first message and other data or signaling.

In an implementation, the third wireless resource may be a third CG configuration, and the third CG configuration may also be referred to as a third CG PUSCH. For example, the terminal may send the first message via CG-Uplink Control Information (CG-UCI).

Similarly, the third CG configuration may be one of: a CG configuration determined according to agreement in a protocol, a CG configuration determined by the network device and sent to the terminal, or a CG configuration determined by the terminal and sent to the network device.

For example, the third CG configuration may be a non-idle CG configuration. For example, the third CG configuration may carry both the first message and data service. The terminal may send the first message on the non-idle CG configuration.

In this way, the first message may be sent via the CG PUSCH.

In another implementation, the third wireless resource may be one or more CG transmission occasions.

For example, the terminal may send the first message via a CG transmission occasion.

For another example, the terminal may perform uplink transmission on a CG transmission occasion in a non-idle state, send the first message on the CG transmission occasion, and indicate the resource usage states of the first wireless resources via the first message.

In another implementation, the third wireless resource may be a dynamic grant physical uplink shared channel (DG PUSCH).

In this way, the first message may be sent via the DG PUSCH.

In yet another implementation, the third wireless resource may be a Physical Uplink Control Channel (PUCCH).

In this way, the first message may be sent via the PUCCH.

In some embodiments of the present disclosure, the first wireless resources may be CG TOs, the first parameter field may include a plurality of first indication bits, and one first indication bit is configured to indicate a resource usage state of one CG transmission occasion.

In some embodiments, the resource usage state may be an idle state or an occupied state.

For example, a value of the first indication bit being 1 may represent that a resource usage state of a CG transmission occasion corresponding to the first indication bit is the occupied state, and the value of the first indication bit being 0 may represent that the resource usage state of the CG transmission occasion corresponding to the first indication bit is the idle state.

For another example, the value of the first indication bit being 1 may represent that the resource usage state of the CG transmission occasion corresponding to the first indication bit is the idle state, and the value of the first indication bit being 0 may represent that the resource usage state of the CG transmission occasion corresponding to the first indication bit is the occupied state.

In some embodiments, the resource usage state may be the idle state or a non-idle state.

For example, the value of the first indication bit being 1 may represent that the resource usage state of the CG transmission occasion corresponding to the first indication bit is the idle state, and the value of the first indication bit being 0 may represent that the resource usage state of the CG transmission occasion corresponding to the first indication bit is the non-idle state.

For another example, the value of the first indication bit being 1 may represent that the resource usage state of the CG transmission occasion corresponding to the first indication bit is the non-idle state, and the value of the first indication bit being 0 may represent that the resource usage state of the CG transmission occasion corresponding to the first indication bit is the idle state.

In some embodiments, the resource usage state may be the occupied state or a non-occupied state.

For example, the value of the first indication bit being 1 may represent that the resource usage state of the CG transmission occasion corresponding to the first indication bit is the occupied state, and the value of the first indication bit being 0 may represent that the resource usage state of the CG transmission occasion corresponding to the first indication bit is the non-occupied state.

For another example, the value of the first indication bit being 1 may represent that the resource usage state of the CG transmission occasion corresponding to the first indication bit is the non-occupied state, and the value of the first indication bit being 0 may represent that the resource usage state of the CG transmission occasion corresponding to the first indication bit is the occupied state.

In this way, the resource usage state of one CG transmission occasion may be indicated by the first indication bit.

In some embodiments of the present disclosure, the terminal may determine an order of the plurality of CG configurations, and determine corresponding relationships between the CG transmission occasions and the first indication bits according to the order of the plurality of CG configurations.

For example, all CG transmission occasions of the sorted CG configurations may be cascaded, and the first to the last first indication bits in the first parameter field sequentially correspond to the first to the last cascaded CG transmission occasions.

In this way, the terminal may determine the corresponding relationships between the CG transmission occasions and the first indication bits, so as to indicate the resource usage states of the CG transmission occasions via the first parameter field in the first message.

In some embodiments, the terminal may determine the above order of the plurality of CG configurations by sorting the plurality of CG configurations according to CG parameters of the CG configurations.

In an implementation, a CG parameter of a CG configuration may include a single item. The CG configurations may be sorted in an ascending or descending order of the CG parameters to obtain the order of the plurality of CG configurations.

In another implementation, the CG parameter may include a plurality of items. For example, the CG parameters may include a first CG parameter, a second CG parameter, a third CG parameter, a fourth CG parameter and a fifth CG parameter. First, the CG configurations may be sorted according to the first CG parameter. In a case where there are CG configurations having the same first CG parameter, the CG configurations having the same first CG parameter are sorted according to the second CG parameter. In a case where there are CG configurations having the same first CG parameter and second parameter, the CG configurations having the same first CG parameter and second CG parameter are sorted according to the third CG parameter, and so on.

In some implementations, the CG parameter may include at least one of: a configuration index of the CG configuration; frequency-domain position information of the CG configuration; time-domain position information of the CG configuration; the number of CG transmission occasions included in the CG configuration; or a priority of the CG configuration.

For example, the CG parameter may include the configuration index, and the order of the plurality of CG configurations may be obtained by sorting the plurality of CG configurations in an ascending or descending order according to the configuration indexes.

For another example, the CG parameters may include the frequency-domain position information and the time-domain position information. The CG configurations may be sorted based on the frequency-domain position information first, and for CG configurations having the same frequency-domain position information, the CG configurations may be sorted based on the time-domain position information.

For another example, the CG parameter may include the above frequency-domain position information, the time-domain position information, the number of CG transmission occasions, and the priority of the CG configuration.

It is to be noted that the CG parameter may be any combination of the above parameters, which is not repeated here.

In this way, the order of the plurality of CG configurations may be determined by sorting the plurality of CG configurations using at least one of the above CG parameters.

In some embodiments of the present disclosure, the first parameter field may be a one-dimensional bitmap.

In an implementation, the number of the first indication bits included in the one-dimensional bitmap may be greater than or equal to the total number of CG transmission occasions included in the plurality of CG configurations.

For example, the network device allocates N CG configurations to the terminal, and each CG configuration includes M CG transmission occasions. The number of first indication bits included in the one-dimensional bitmap is L, and L may be greater than or equal to N*M.

In another implementation, the number of the first indication bits included in the one-dimensional bitmap may be greater than or equal to the number of valid CG transmission occasions. The number of valid CG transmission occasions may be the total number of valid CG transmission occasions included in the plurality of CG configurations.

The valid CG transmission occasions may be configured to indicate CG transmission occasions included in a first time window in a time domain. The first time window may be one of: a duration agreed in a protocol, a duration determined by the network device and sent to the terminal, or a duration determined by the terminal and sent to the network device.

In an implementation, the first time window may be a valid time-domain range indicated by the first parameter field.

The first time window may take the number of symbols, the number of time slots, the number of CG configuration periods, or the number of CG transmission occasions as a time unit. For example, the first time window may be 7 or 14 symbols. For another example, the first time window may be 4 or 8 time slots. For another example, the first time window may be one or two CG configuration period(s). For another example, the first time window may be 4 or 8 CG transmission occasions.

In another implementation, the first time window may be a valid time-domain range agreed in a protocol.

The first time window may take the number of symbols, the number of time slots, the number of CG configuration periods, or the number of CG transmission occasions as a time unit. For example, as agreed in the protocol, the first time window is 2 or 4 time slots. For another example, as agreed in the protocol, the first time window is one or two CG configuration period(s). For another example, as agreed in the protocol, the first time window is an interval from the start of the first CG period to the end of the last CG period. For another example, as agreed in the protocol, the first time window is 4 or 8 CG transmission occasions.

In some embodiments, the terminal may determine the order of the plurality of CG configurations, and determine corresponding relationships between the CG transmission occasions and the first indication bits in the one-dimensional bitmap according to the order of the plurality of CG configurations.

For example, first, the terminal may determine the above order of the plurality of CG configurations by sorting the plurality of CG configurations according to the CG parameters of the CG configurations.

Next, an order of the CG transmission occasions is determined according to the order of the plurality of CG configurations and a time order of the CG transmission occasions in the CG configurations.

Finally, the corresponding relationships between the CG transmission occasions and the first indication bits are determined according to the order of the CG transmission occasions.

For example, the terminal may sort the CG configurations according to the configuration indexes, and cascade all CG transmission occasions or valid CG transmission occasions of the sorted CG configurations. The first to the last first indication bits in the first parameter field sequentially correspond to the first to the last cascaded CG transmission occasions.

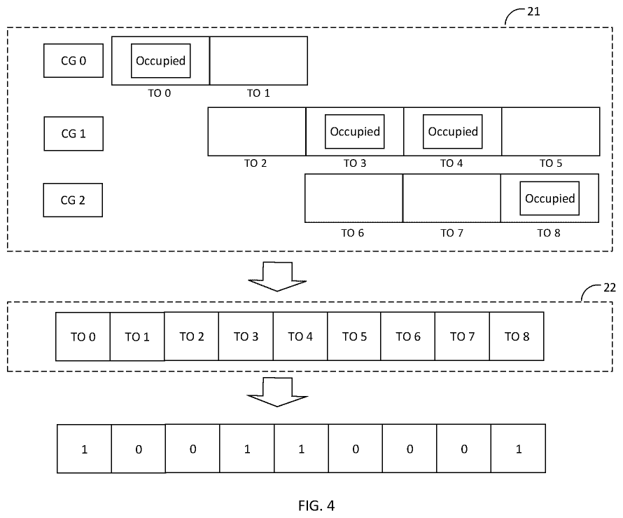

FIG. 4 is a schematic diagram of a plurality of CG configurations and a first parameter field according to an example. As shown in FIG. 4, the network device may allocate a plurality of CG configurations 21 (such as three) to the terminal. The plurality of CG configurations 21 may include CG0, CG1, and CG2, and each CG configuration may include a plurality of first wireless resources. For example, first wireless resources included in CG0 may be TO0 and TO1, first wireless resources included in CG1 may be TO2, TO3, TO4, and TO5, and first wireless resources included in CG2 may be TO6, TO7, and TO8. The first parameter field is a one-dimensional bitmap 22. Each bit in the one-dimensional bitmap 22 corresponds to one first wireless resource, and is configured to indicate a resource usage state of the first wireless resource. As shown in FIG. 4, the one-dimensional bitmap 22 includes bit 0 to bit 8, where bit 0 corresponds to TO0, bit 1 corresponds to TO1, and so on, bit 8 corresponds to TO8.

In some examples, a value of each first indication bit may be determined according to whether TO0 to TO8 are occupied. For example, in a case where TO0, TO3, TO4, and TO8 are occupied and the other TOs are idle, values of bit 0, bit 3, bit 4, and bit 8 may be 1, and values of other first indication bits may be 0.

In this way, the terminal may indicate the resource usage states of the first wireless resources (i.e., the CG transmission occasions) via the one-dimensional bitmap.

In some other embodiments of the present disclosure, the above parameter field may be a two-dimensional bitmap.

The number of the first indication bits included in the two-dimensional bitmap is L. L is greater than or equal to a product of N and M, N is the number of CG configurations, M is the number of CG transmission occasions in a first CG configuration, and the first CG configuration is a CG configuration having the maximum number of CG transmission occasions among the N CG configurations.

For example, the two-dimensional bitmap may include at least N sub-bitmaps, each of the sub-bitmaps may include at least M bits, and the sub-bitmap may be a one-dimensional bitmap.

In some embodiments, the first message may further include a second parameter field, and the second parameter field may be configured to indicate the number M of the CG transmission occasions in the first CG configuration.

In some embodiments, the first message may further include a third parameter field, and the third parameter field may be configured to indicate the number N of the CG configurations.

In some embodiments, the terminal may determine corresponding relationships between the CG transmission occasions and the first indication bits in the following manner.

First, at least N sub-bitmaps are obtained by grouping the L first indication bits according to the number N of the CG configurations.

The number of first indication bits included in each of the sub-bitmaps is greater than or equal to M.

In an implementation, first K first indication bits may be obtained from the L first indication bits, where K is equal to the product of N and M. The K first indication bits are evenly divided into N sub-bitmaps, and the number of first indication bits included in each of the sub-bitmaps is equal to M.

In another implementation, the L first indication bits may be evenly divided into N sub-bitmaps, and the number of first indication bits included in each of the sub-bitmaps is greater than or equal to M.

Next, sub-bitmaps corresponding to the CG configurations are determined according to the order of the plurality of CG configurations.

For example, the N sub-bitmaps may be sequentially in correspondence according to the order of the plurality of CG configurations. The first CG configuration corresponds to the first sub-bitmap, the second CG configuration correspond to the second sub-bitmap, and so on, the N-th CG configuration corresponds to the N-th sub-bitmap.

Finally, the corresponding relationships between the CG transmission occasions and the first indication bits are determined according to a time order of the CG transmission occasions in the CG configurations.

FIG. 5 is a schematic diagram of a plurality of CG configurations and a first parameter field according to another example. As shown in FIG. 5, the network device may allocate a plurality of CG configurations 21 (such as three) to the terminal. The plurality of CG configurations 21 may include CG0, CG1, and CG2, and each CG configuration may include a plurality of first wireless resources. For example, first wireless resources included in CGO may be TO0 and TO1, first wireless resources included in CG1 may be TO2, TO3, TO4, and TO5, and first wireless resources included in CG2 may be TO6, TO7, and TO8.

As shown in FIG. 5, the first parameter field may be a two-dimensional bitmap 23, and the two-dimensional bitmap 23 may include three sub-bitmaps. For example, each row of bits in FIG. 5 is taken as a sub-bitmap, and each sub-bitmap may include four bits. A first sub-bitmap corresponding to the first row may correspond to CGO, and first two bits in the first sub-bitmap sequentially correspond to TO0 and TO1 respectively. A second sub-bitmap corresponding to the second row may correspond to CG1, and first four bits in the second sub-bitmap sequentially correspond to TO2, TO3, TO4, and TO5 respectively. A third sub-bitmap corresponding to the third row may correspond to CG2, and first three bits in the third sub-bitmap sequentially correspond to TO6, TO7, and TO8 respectively. The other bits may be invalid bits.

In some examples, a value of each first indication bit may be determined according to whether TO0 to TO8 are occupied. For example, in a case where TO0, TO3, TO4, and TO8 are occupied and the other TOs are idle, values of the first bit in the first sub-bitmap, the second bit and the third bit in the second sub-bitmap, and the third bit in the third sub-bitmap may all be 1, and values of other valid first indication bits may be 0.

In this way, the terminal may indicate the resource usage states of the first wireless resources (i.e., the CG transmission occasions) via the two-dimensional bitmap.

In some embodiments of the present disclosure, the first message may further include a fourth parameter field. The fourth parameter field may be configured to indicate a second CG configuration, and the second CG configuration is at least one of the plurality of CG configurations.

The first wireless resources indicated by the above first parameter field may be a subset or full set of wireless resources included in the second CG configuration. For example, the first parameter field may be configured to indicate resource usage states of first wireless resources included in the second CG configuration.

In some embodiments, the fourth parameter field may include at least one third indication bit, and the third indication bit is configured to indicate the second CG configuration.

For example, the network device allocates four CG configurations, i.e., CG0, CG1, CG2, and CG3, to the terminal. The fourth parameter field may include four third indication bits, and the first to the last bits sequentially correspond to CG0, CG1, CG2, and CG3.

In some other embodiments, the fourth parameter field may include a configuration index corresponding to the second CG configuration. There may be one or more configuration indexes.

For example, the network device allocates four CG configurations, i.e., CG0, CG1, CG2, and CG3, to the terminal. The configuration index may be 2 bits, and values 00, 01, 10, and 11 of the configuration index may sequentially correspond to CG0, CG1, CG2, and CG3.

In some embodiments, the second CG configuration may be all CG configurations allocated by the network device to the terminal in a case where the first message does not include the fourth parameter field.

In some other embodiments, the second CG configuration may be a CG configuration for sending the first message in a case where the first message does not include the fourth parameter field.

In this way, the terminal may indicate usage states of first wireless resources in part or all of the CG configurations via the first parameter field and the fourth parameter field.

In some other embodiments of the present disclosure, the above first wireless resources may be CG configurations, the first parameter field may include a plurality of second indication bits, and one second indication bit may be configured to indicate a resource usage state of one CG configuration.

Similarly, the above first parameter field may be a one-dimensional bitmap consisting of a plurality of second indication bits.

For example, the network device allocates N CG configurations to the terminal, and the first parameter field may be a one-dimensional bitmap consisting of N second indication bits.

In some embodiments, an order of the plurality of CG configurations may be determined, and corresponding relationships between the CG configurations and the second indication bits may be determined according to the order of the plurality of CG configurations. For example, the first to the last second indication bits in the first parameter field sequentially correspond to the first to the last sorted CG configurations.

In this way, the terminal may indicate, via the first parameter field, the usage states of part or all of the CG configurations.

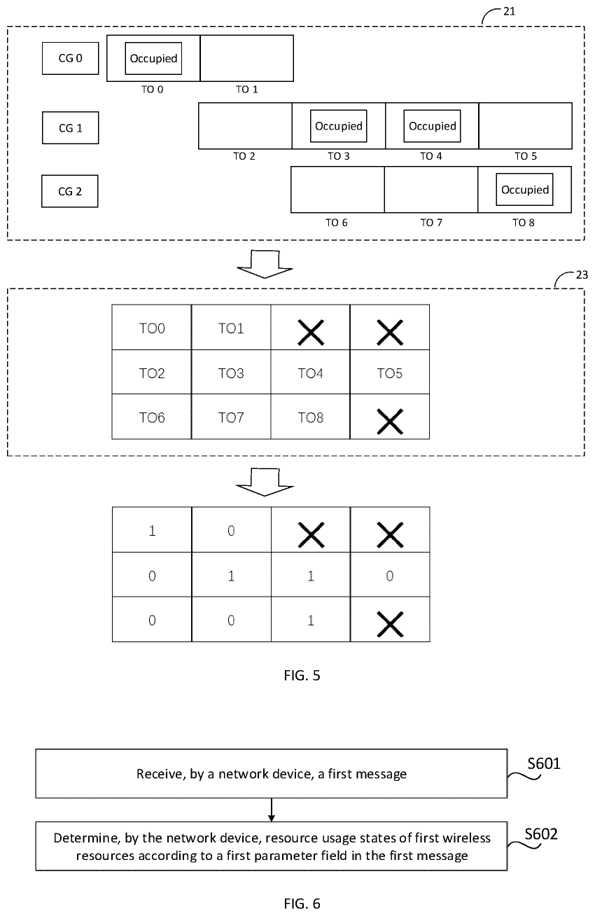

FIG. 6 is a flowchart of a method for determining a resource state according to an example. As shown in FIG. 6, the method may be performed by a network device in the above communication system. The method may include steps S601 and S602.

In step S601, the network device receives a first message.

For example, the network device may receive the first message sent by a terminal.

In step S602, the network device determines resource usage states of first wireless resources according to a first parameter field in the first message.

In some embodiments, the first message may include a first parameter field, and the first parameter field may be configured to indicate the resource usage states of the first wireless resources.

In an implementation, the first wireless resources may be wireless resources allocated by the network device to the terminal based on one or more CG configurations.

In another implementation, the first wireless resources may be wireless resources corresponding to a plurality of CG configurations, and the CG configurations may be wireless resources allocated by the network device to the terminal based on a CG configuration manner.

In some embodiments, the resource usage state may be an idle state or an occupied state.

It is to be noted that the network device may allocate a plurality of CG configurations to the terminal, and the first wireless resources may be all or part of CG transmission occasions included in the plurality of CG configurations.

In some embodiments, the plurality of CG configurations allocated by the network device to the terminal may be a plurality of CG configurations having the same frequency-domain configurations but different time-domain configurations, a plurality of CG configurations having different frequency-domain configurations and different time-domain configurations, or a plurality of CG configurations having different frequency-domain configurations but the same time-domain configurations.

In some embodiments, different CG configurations may have the same or different frequency-domain positions, and similarly, different CG configurations may have the same or different time-domain positions. For example, different CG configurations may have the same frequency-domain positions but different time-domain positions. For another example, different CG configurations may have different frequency-domain positions but the same time-domain positions. For another example, different CG configurations may have different frequency-domain positions and different time-domain positions.

In some other embodiments, the first message may include a second parameter field and the above first parameter field. The second parameter field may be configured to indicate the number M of first wireless resources in a first CG configuration, and the first CG configuration is a CG configuration having the maximum number of first wireless resources among the plurality of CG configurations.

In some other embodiments, the first message includes the above first parameter field. The network device may determine the second parameter field when allocating the CG configurations to the terminal. In other words, the number M of the first wireless resources in the first CG configuration is determined. The first CG configuration is a CG configuration having the maximum number of first wireless resources among the plurality of CG configurations.

Similarly, the terminal may also determine the second parameter field when obtaining the CG configurations according to a second message or a third message sent by the network device.

In some other embodiments, the first message may include a third parameter field and the above first parameter field, and the third parameter field may be configured to indicate the number N of the CG configurations.

In some other embodiments, the first message may include the above first parameter field. The network device may determine the third parameter field when allocating the CG configurations to the terminal. In other words, the number N of the CG configurations is determined.

The terminal may determine the third parameter field when obtaining the CG configurations according to the second message or the third message sent by the network device.

In some other embodiments, the first message may include the above first parameter field, the second parameter field, and the third parameter field.

In some embodiments of the present disclosure, the network device may receive the first message sent by the terminal via a third wireless resource. Similarly, the terminal may also send the first message via the third wireless resource.

In an implementation, the third wireless resource may be a wireless resource determined according to agreement in a protocol.

In another implementation, the third wireless resource may be a wireless resource determined by the network device, and the network device may further send information of the third wireless resource to the terminal.

In another implementation, the third wireless resource may be a wireless resource determined by the terminal, and the terminal may further send information of the third wireless resource to the network device.

It is to be noted that the third wireless resource may simply carry the first message, or may carry both the first message and other data or signaling.

In an implementation, the third wireless resource may be a third CG configuration, and the third CG configuration may also be referred to as a third CG PUSCH. In this way, the first message may be received via the CG PUSCH.

In another implementation, the third wireless resource may be a DG PUSCH. In this way, the first message may be received via the DG PUSCH.

In another implementation, the third wireless resource may be a PUCCH. In this way, the first message may be received via the PUCCH.

In some embodiments of the present disclosure, the first wireless resources may be CG TOs, the first parameter field may include a plurality of first indication bits, and one first indication bit is configured to indicate a resource usage state of one CG transmission occasion.

In some embodiments of the present disclosure, the network device may determine an order of the plurality of CG configurations, and determine corresponding relationships between the CG transmission occasions and the first indication bits according to the order of the plurality of CG configurations.

In some embodiments, the network device may determine the above order of the plurality of CG configurations by sorting the plurality of CG configurations according to CG parameters of the CG configurations.

In some implementations, a CG parameter of a CG configuration may include at least one of: a configuration index of the CG configuration; frequency-domain position information of the CG configuration; time-domain position information of the CG configuration; the number of CG transmission occasions included in the CG configuration; or a priority of the CG configuration.

In some embodiments of the present disclosure, the first parameter field may be a one-dimensional bitmap.

In an implementation, the number of the first indication bits included in the one-dimensional bitmap may be greater than or equal to the total number of CG transmission occasions included in the plurality of CG configurations.

In another implementation, the number of the first indication bits included in the one-dimensional bitmap may be greater than or equal to the number of valid CG transmission occasions. The number of valid CG transmission occasions may be the total number of valid CG transmission occasions included in the plurality of CG configurations.

The valid CG transmission occasions may be configured to indicate CG transmission occasions included in a first time window in a time domain. The first time window may be one of: a duration agreed in a protocol, a duration determined by the network device and sent to the terminal, or a duration determined by the terminal and sent to the network device.

The first time window may take the number of symbols, the number of time slots, the number of CG configuration periods, or the number of CG transmission occasions as a time unit.

In an implementation, the first time window may be a valid time-domain range indicated by the first parameter field. In another implementation, the first time window may be a valid time-domain range agreed in a protocol.

In some embodiments, the network device may determine the order of the plurality of CG configurations, and determine corresponding relationships between the CG transmission occasions and the first indication bits in the one-dimensional bitmap according to the order of the plurality of CG configurations.

For example, first, the above order of the plurality of CG configurations is determined by sorting the plurality of CG configurations according to the CG parameters of the CG configurations.

Next, an order of the CG transmission occasions is determined according to the order of the plurality of CG configurations and a time order of the CG transmission occasions in the CG configurations.

Finally, the corresponding relationships between the CG transmission occasions and the first indication bits are determined according to the order of the CG transmission occasions.

In some other embodiments of the present disclosure, the above parameter field may be a two-dimensional bitmap.

The number of the first indication bits included in the two-dimensional bitmap is L. L is greater than or equal to a product of N and M, N is the number of the CG configurations, M is the number of CG transmission occasions in the first CG configuration, and the first CG configuration is a CG configuration having the maximum number of CG transmission occasions among the N CG configurations.

In some embodiments, the first message may further include a second parameter field, and the second parameter field may be configured to indicate the number M of the CG transmission occasions in the first CG configuration.

In some embodiments, the first message may further include a third parameter field, and the third parameter field may be configured to indicate the number N of the CG configurations.

In some embodiments, the network device may determine corresponding relationships between the CG transmission occasions and the first indication bits in the following manner.

First, at least N sub-bitmaps are obtained by grouping the L first indication bits according to the number N of the CG configurations.

The number of first indication bits included in each of the sub-bitmaps is greater than or equal to M.

In an implementation, first K first indication bits may be obtained from the L first indication bits, where K is equal to the product of N and M. The K first indication bits are evenly divided into N sub-bitmaps, and the number of first indication bits included in each of the sub-bitmaps is equal to M.

In another implementation, the L first indication bits may be evenly divided into N sub-bitmaps, and the number of first indication bits included in each of the sub-bitmaps is greater than or equal to M.

Next, sub-bitmaps corresponding to the CG configurations are determined according to the order of the plurality of CG configurations.

Finally, the corresponding relationships between the CG transmission occasions and the first indication bits are determined according to a time order of the CG transmission occasions in the CG configurations.

In some embodiments of the present disclosure, the first message may further include a fourth parameter field. The fourth parameter field may be configured to indicate a second CG configuration, and the second CG configuration is at least one of the plurality of CG configurations.

The first wireless resources indicated by the above first parameter field may be a subset or full set of wireless resources included in the second CG configuration. For example, the first parameter field may be configured to indicate resource usage states of first wireless resources included in the second CG configuration.

In some embodiments, the fourth parameter field may include at least one third indication bit, and the third indication bit is configured to indicate the second CG configuration.

In some other embodiments, the fourth parameter field may include a configuration index corresponding to the second CG configuration. There may be one or more configuration indexes.

In some embodiments, the second CG configuration may be all CG configurations allocated by the network device to the terminal in a case where the first message does not include the fourth parameter field.

In some other embodiments, the second CG configuration may be a CG configuration for sending the first message in a case where the first message does not include the fourth parameter field.

In some other embodiments of the present disclosure, the above first wireless resources may be CG configurations, the first parameter field may include a plurality of second indication bits, and one second indication bit may be configured to indicate a resource usage state of one CG configuration.

In some embodiments, the network device may reuse a first wireless resource with a resource usage state being the idle state.

In an implementation, the network device may allocate, based on a manner of dynamic scheduling, a first wireless resource with a resource usage state being the idle state to a terminal that sends the first message for use.

In another implementation, the network device may allocate a first wireless resource with a resource usage state being the idle state to another terminal for use, and the allocation manner may be based on dynamic scheduling or CG. The other terminal is any terminal in the network other than the terminal that sends the first message.

In some embodiments of the present disclosure, prior to the step S601, the network device may also allocate CG configurations to the terminal. The specific manner for allocating the CG configurations may refer to the description in the foregoing embodiments of the present disclosure and is not repeated here.

It is to be noted that the embodiment may be combined with the foregoing embodiments or implementations and various solutions of the present disclosure in case of no contradiction. The specific implementation of the above steps in the embodiment may also refer to the description in the foregoing embodiments of the present disclosure and is not repeated here.

By adopting the above method, the network device receives the first message sent by the terminal, where the first message may include the first parameter field, the first parameter field may be configured to indicate the resource usage states of the first wireless resources, and the first wireless resources are wireless resources corresponding to a plurality of CG configurations. In this way, the network device may determine the resource usage states of the first wireless resources according to the first message, so as to flexibly use and schedule the first wireless resources according to the resource usage states.

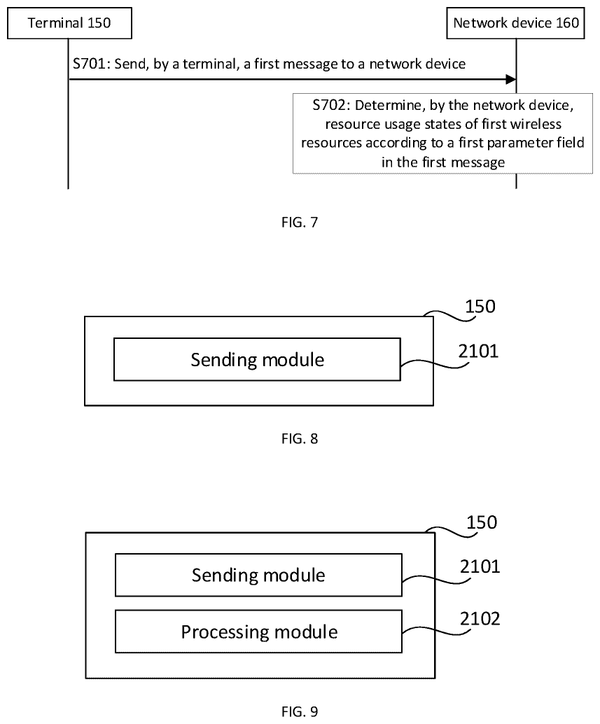

FIG. 7 is a flowchart of a method for determining a resource state according to an example. As shown in FIG. 7, the method may be performed by the communication system. The method may include steps S701 and S702.

In step S701, a terminal 150 sends a first message to a network device 160.

In some embodiments, the first message may include a first parameter field, and the first parameter field may be configured to indicate resource usage states of first wireless resources.

In an implementation, the first wireless resources may be wireless resources allocated by the network device to the terminal based on a plurality of CG configurations.

In another implementation, the first wireless resources may be wireless resources corresponding to a plurality of CG configurations, and the CG configurations may be wireless resources allocated by the network device to the terminal based on a CG configuration manner.

In step S702, the network device 160 determines the resource usage states of the first wireless resources according to the first parameter field in the first message.

It is to be noted that the embodiment may be combined with the foregoing embodiments or implementations and various solutions of the present disclosure in case of no contradiction. The specific implementation of the above steps in the embodiment may also refer to the description in the foregoing embodiments of the present disclosure and is not repeated here.

By adopting the above method, the network device may determine the resource usage states of the first wireless resources according to the first message, so as to flexibly use and schedule the first wireless resources according to the resource usage states.

In an example, the present disclosure further provides a communication system. The communication system may include a terminal and a network device. The terminal may perform the method for determining the resource state, which involves the terminal, in the foregoing embodiments of the present disclosure, and the network device may perform the method for determining the resource state, which involves the network device, in the foregoing embodiments of the present disclosure.

FIG. 8 is a block diagram of a terminal 150 according to an example. As shown in FIG. 8, the terminal 150 may include a sending module 2101.

The sending module 2101 is configured to send a first message to a network device. The first message includes a first parameter field, the first parameter field is configured to indicate resource usage states of first wireless resources, and the first wireless resources are wireless resources allocated by the network device to the terminal based on a plurality of CG configurations.

In some embodiments, the first wireless resources are CG transmission occasions, the first parameter field includes a plurality of first indication bits, and one of the plurality of first indication bits is configured to indicate a resource usage state of one of the CG transmission occasions.

In some embodiments, the terminal 150 may further include a processing module 2102 (see FIG. 9).

The processing module 2102 is configured to determine an order of the plurality of CG configurations; and determine corresponding relationships between the CG transmission occasions and the first indication bits according to the order of the plurality of CG configurations.

FIG. 9 is a block diagram of a terminal 150 according to an example. As shown in FIG. 9, the terminal 150 may include the sending module 2101, as described with reference to FIG. 8, and further include a processing module 2102.

The processing module 2102 is configured to determine the order of the plurality of CG configurations by sorting the plurality of CG configurations according to CG parameters of the CG configurations. A CG parameter of a CG configuration includes at least one of: a configuration index of the CG configuration; frequency-domain position information of the CG configuration; time-domain position information of the CG configuration; the number of CG transmission occasions included in the CG configuration; or a priority of the CG configuration.

In some embodiments, the first parameter field is a one-dimensional bitmap. The number of the first indication bits included in the one-dimensional bitmap is greater than or equal to the number of valid CG transmission occasions, and the number of the valid CG transmission occasions is the total number of valid CG transmission occasions included in the plurality of CG configurations.

In some embodiments, the valid CG transmission occasions are configured to indicate CG transmission occasions included in a first time window in a time domain. The first time window is one of: a duration agreed in a protocol, a duration determined by the network device and sent to the terminal, or a duration determined by the terminal and sent to the network device.

In some embodiments, the processing module 2102 is configured to: determine an order of the CG transmission occasions according to the order of the plurality of CG configurations and a time order of the CG transmission occasions in the CG configurations; and determine the corresponding relationships between the CG transmission occasions and the first indication bits according to the order of the CG transmission occasions.

In some embodiments, the first parameter field is a two-dimensional bitmap. The number of the first indication bits included in the two-dimensional bitmap is L, L is greater than or equal to a product of N and M, N is the number of the CG configurations, M is the number of CG transmission occasions in a first CG configuration, and the first CG configuration is a CG configuration having the maximum number of CG transmission occasions among the N CG configurations.

In some embodiments, the first message further includes a second parameter field, and the second parameter field is configured to indicate the number M of the CG transmission occasions in the first CG configuration.

In some embodiments, the processing module 2102 is configured to: obtain at least N sub-bitmaps by grouping the L first indication bits according to N, where the number of first indication bits included in each of the at least N sub-bitmaps is greater than or equal to M; determine sub-bitmaps corresponding to the CG configurations according to the order of the plurality of CG configurations; and determine the corresponding relationships between the CG transmission occasions and the first indication bits according to the time order of the CG transmission occasions in the CG configurations.

In some embodiments, the processing module 2102 is configured to obtain first K first indication bits from the L first indication bits, where K is equal to the product of N and M; and evenly divide the K first indication bits into N sub-bitmaps, where the number of first indication bits included in each of the N sub-bitmaps is equal to M.

In some embodiments, the processing module 2102 is configured to evenly divide the L first indication bits into N sub-bitmaps, where the number of first indication bits included in each of the N sub-bitmaps is greater than or equal to M.

In some embodiments, the first wireless resources are the CG configurations, the first parameter field includes a plurality of second indication bits, and one of the plurality of second indication bits is configured to indicate a resource usage state of one of the CG configurations.

In some embodiments, the first message further includes a third parameter field, and the third parameter field is configured to indicate the number of the CG configurations.

In some embodiments, the first message further includes a fourth parameter field, the fourth parameter field is configured to indicate a second CG configuration, and the second CG configuration is at least one of the plurality of CG configurations.

In some embodiments, the fourth parameter field includes at least one third indication bit, and the third indication bit is configured to indicate the second CG configuration; or the fourth parameter field includes a configuration index corresponding to the second CG configuration.

In some embodiments, the second CG configuration is the plurality of CG configurations in a case where the first message does not include the fourth parameter field; or the second CG configuration is a CG configuration for sending the first message in a case where the first message does not include the fourth parameter field.

In some embodiments, the sending module 2101 is configured to send, via a third CG configuration, the first message to the network device. The third CG configuration is one of: a CG configuration determined according to agreement in a protocol, a CG configuration determined by the network device and sent to the terminal, or a CG configuration determined by the terminal and sent to the network device.

In some embodiments, the resource usage state is an idle state or an occupied state.

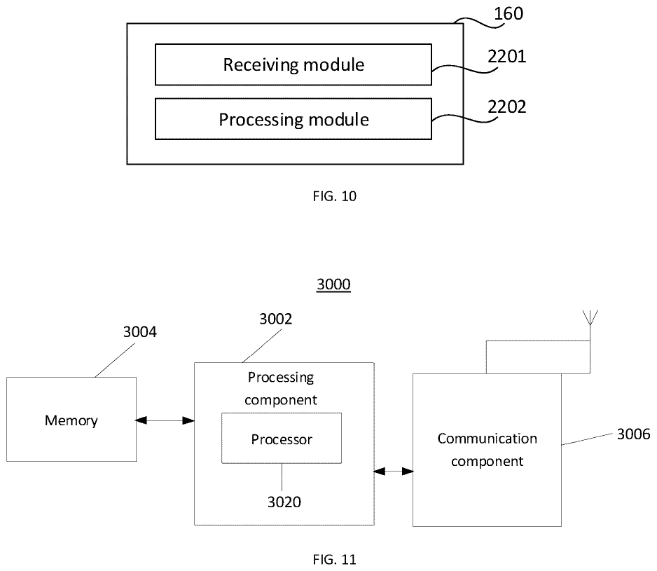

FIG. 10 is a block diagram of a network device 160 according to an example. As shown in FIG. 10, the network device 160 may include a receiving module 2201 and a processing module 2202.

The receiving module 2201 is configured to receive a first message sent by a terminal. The first message includes a first parameter field, the first parameter field is configured to indicate resource usage states of first wireless resources, and the first wireless resources are wireless resources allocated by the network device to the terminal based on a plurality of CG configurations.

The processing module 2202 is configured to determine the resource usage states of the first wireless resources according to the first parameter field in the first message.

In some embodiments, the first wireless resources are CG transmission occasions, the first parameter field includes a plurality of first indication bits, and one of the plurality of first indication bits is configured to indicate a resource usage state of one of the CG transmission occasions.

In some embodiments, the processing module 2202 is further configured to determine an order of the plurality of CG configurations; and determine corresponding relationships between the CG transmission occasions and the first indication bits according to the order of the plurality of CG configurations.

In some embodiments, the processing module 2202 is configured to determine the order of the plurality of CG configurations by sorting the plurality of CG configurations according to CG parameters of the CG configurations. A CG parameter of a CG configuration includes at least one of: a configuration index of the CG configuration; frequency-domain position information of the CG configuration; time-domain position information of the CG configuration; the number of CG transmission occasions included in the CG configuration; or a priority of the CG configuration.

In some embodiments, the first parameter field is a one-dimensional bitmap. The number of the first indication bits included in the one-dimensional bitmap is greater than or equal to the number of valid CG transmission occasions, and the number of the valid CG transmission occasions is the total number of valid CG transmission occasions included in the plurality of CG configurations.

In some embodiments, the valid CG transmission occasions are configured to indicate CG transmission occasions included in a first time window in a time domain. The first time window is one of: a duration agreed in a protocol, a duration determined by the network device and sent to the terminal, or a duration determined by the terminal and sent to the network device.

In some embodiments, the processing module 2202 is further configured to: determine an order of the CG transmission occasions according to the order of the plurality of CG configurations and a time order of the CG transmission occasions in the CG configurations; and determine the corresponding relationships between the CG transmission occasions and the first indication bits according to the order of the CG transmission occasions.

In some embodiments, the first parameter field is a two-dimensional bitmap. The number of the first indication bits included in the two-dimensional bitmap is L, L is greater than or equal to a product of N and M, N is the number of the CG configurations, M is the number of CG transmission occasions in a first CG configuration, and the first CG configuration is a CG configuration having the maximum number of CG transmission occasions among the N CG configurations.

In some embodiments, the first message further includes a second parameter field, and the second parameter field is configured to indicate the number M of the CG transmission occasions in the first CG configuration.

In some embodiments, the processing module 2202 is further configured to: obtain at least N sub-bitmaps by grouping the L first indication bits according to N, where the number of first indication bits included in each of the at least N sub-bitmaps is greater than or equal to M; determine sub-bitmaps corresponding to the CG configurations according to the order of the plurality of CG configurations; and determine the corresponding relationships between the CG transmission occasions and the first indication bits according to the time order of the CG transmission occasions in the CG configurations.

In some embodiments, the processing module 2202 is further configured to obtain first K first indication bits from the L first indication bits, where K is equal to the product of N and M; and evenly divide the K first indication bits into N sub-bitmaps, where the number of first indication bits included in each of the N sub-bitmaps is equal to M.

In some embodiments, the processing module 2202 is further configured to evenly divide the L first indication bits into N sub-bitmaps, where the number of first indication bits included in each of the N sub-bitmaps is greater than or equal to M.

In some embodiments, the first wireless resources are the CG configurations, the first parameter field includes a plurality of second indication bits, and one of the plurality of second indication bits is configured to indicate a resource usage state of one of the CG configurations.

In some embodiments, the first message further includes a third parameter field, and the third parameter field is configured to indicate the number of the CG configurations.

In some embodiments, the first message further includes a fourth parameter field, the fourth parameter field is configured to indicate a second CG configuration, and the second CG configuration is at least one of the plurality of CG configurations.

In some embodiments, the fourth parameter field includes at least one third indication bit, and the third indication bit is configured to indicate the second CG configuration; or the fourth parameter field includes a configuration index corresponding to the second CG configuration.

In some embodiments, the second CG configuration is the plurality of CG configurations in a case where the first message does not include the fourth parameter field; or the second CG configuration is a CG configuration for sending the first message in a case where the first message does not include the fourth parameter field.

In some embodiments, the receiving module 2201 is configured to receive, via a third CG configuration, the first message sent by the terminal. The third CG configuration is one of: a CG configuration determined according to agreement in a protocol, a CG configuration determined by the network device and sent to the terminal, or a CG configuration determined by the terminal and sent to the network device.

In some embodiments, the resource usage state is an idle state or an occupied state.

For the devices in the included embodiments, specific manners for each module to perform operations have already been described in detail in the embodiments related to the method and are not repeated here.

FIG. 11 is a block diagram of a device for determining a resource state according to an example. A device 3000 for determining a resource state may be the terminal 150 or may be the network device 160 in the communication system shown in FIG. 1.

Referring to FIG. 11, the device 3000 may include one or more of a processing component 3002, a memory 3004, and a communication component 3006.

The processing component 3002 may be configured to control overall operations of the device 3000, such as operations related to display, phone calls, data communications, camera operations and recording operations. The processing component 3002 may include one or more processors 3020 for executing instructions to complete all or part of steps of the method for determining the resource state as described above. Additionally, the processing component 3002 may include one or more modules to facilitate interaction between the processing component 3002 and other components. For example, the processing component 3002 may include a multimedia module to facilitate interaction between the multimedia component and the processing component 3002. The processing modules 2102 and 2202 of FIGS. 9 and 10 may be the processor 3020.

The memory 3004 is configured to store various types of data to support the operations on the device 3000. Examples of these data include instructions for any applications or methods configured to operate on the device 3000, contact data, phone book data, messages, images, videos, etc. The memory 3004 may be implemented by any types of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 3006 is configured to facilitate wired or wireless communication between the device 3000 and other devices. The device 3000 may access a wireless network based on a communication standard, such as Wi-Fi, 2G, 3G, 4G, 5G, 6G, NB-IOT, eMTC, or a combination thereof. In one example, the communication component 3006 receives a broadcast signal or broadcast-related information from an external broadcast management system via a broadcast channel. In one example, the communication component 3006 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, to perform the method for determining the resource state as described above.

The device 3000 may be an independent electronic device, or a part of an independent electronic device. For example, in an embodiment, the electronic device may be an Integrated Circuit (IC) or a chip. The integrated circuit may be one IC, or may be a set of a plurality of ICs. The chip may include, but is not limited to, the following types: a Graphics Processing Unit (GPU), a Central Processing Unit (CPU), a Field Programmable Gate Array (FPGA), a Digital Signal Processor (DSP), an Application Specific Integrated Circuit (ASIC), a System on Chip (SoC), etc. The above integrated circuit or chip may be configured to execute executable instructions (or codes) to implement the method for determining the resource state as described above. The executable instructions may be stored in the integrated circuit or chip, or may be obtained from other devices or equipment. For example, the integrated circuit or chip includes a processor, a memory, and an interface configured to communicate with other devices. The executable instructions may be stored in the processor. The executable instructions, when executed by the processor, implement the method for determining the resource state as described above. Alternatively, the integrated circuit or chip may receive the executable instructions via the interface and transmit the executable instructions to the processor for execution to implement the method for determining the resource state as described above.

In an example, the present disclosure further provides a non-transitory computer-readable storage medium having stored thereon computer program instructions. The program instructions, when executed by a processor, implement steps of the method for determining the resource state provided by the present disclosure. For example, the computer-readable storage medium may be a non-transitory computer-readable storage medium including instructions. For example, the computer-readable storage medium may be the above memory 3004 including instructions, and the above instructions may be executed by the processor 3020 of the device 3000 to complete the method for determining the resource state. For example, the non-transitory computer-readable storage medium may be a ROM, a random access memory (RAM), a CD-ROM, a magnetic tape, a floppy disk, an optical data storage device, etc.

In another example, a computer program product is further provided. The computer program product includes a computer program executable by a programmable device, and the computer program has a code part configured to, when executed by the programmable device, execute the method for determining the resource state as described above.

A person skilled in the art may easily conceive of other implementations of the present disclosure after considering the specification and practicing the present disclosure. The present application is intended to cover any modifications, applications or adaptions of the present disclosure, and these modifications, applications or adaptions follow general principles of the present disclosure and include common knowledge or conventional technical means in the art that are not disclosed in the present disclosure. The specification and embodiments are merely regarded as illustrative, and the true scope and spirit of the present disclosure are defined by the following claims.

It is to be understood that the present disclosure is not limited to the precise structures described above and shown in the accompanying drawings, and various modifications and changes may be made without departing from its scope. The scope of the present disclosure is merely limited by the appended claims.

1. A method for determining a resource state, performed by a terminal, comprising:
sending a first message to a network device, wherein the first message comprises a first parameter field, the first parameter field is configured to indicate resource usage states of first wireless resources, and the first wireless resources are wireless resources corresponding to a plurality of configured grant (CG) configurations.

2. The method according to claim 1, wherein
the first wireless resources are CG transmission occasions,
the first parameter field comprises a plurality of first indication bits, and
one of the plurality of first indication bits is configured to indicate a resource usage state of one of the CG transmission occasions; and
the method further comprises:
determining an order of the plurality of CG configurations; and
determining corresponding relationships between the CG transmission occasions and the first indication bits based on the order of the plurality of CG configurations.

3. (canceled)

4. The method according to claim 32, wherein
determining the order of the plurality of CG configurations comprises:
determining the order of the plurality of CG configurations by sorting the plurality of CG configurations based on CG parameters of the CG configurations, and
a CG parameter of a CG configuration comprises at least one of:
a configuration index of the CG configuration;
frequency-domain position information of the CG configuration;
time-domain position information of the CG configuration;
a number of CG transmission occasions comprised in the CG configuration; or
a priority of the CG configuration.

5. The method according to claim 2, wherein
the first parameter field is a one-dimensional bitmap,
a number of the first indication bits comprised in the one-dimensional bitmap is greater than or equal to a number of valid CG transmission occasions,
the number of the valid CG transmission occasions is a total number of valid CG transmission occasions comprised in the plurality of CG configurations,
the valid CG transmission occasions are configured to indicate CG transmission occasions comprised in a first time window in a time domain, and the first time window is one of: a duration agreed in a protocol, a duration determined by the network device and sent to the terminal, or a duration determined by the terminal and sent to the network device, and
determining the corresponding relationships between the CG transmission occasions and the first indication bits based on the order of the plurality of CG configurations comprises:
determining an order of the CG transmission occasions based on the order of the plurality of CG configurations and a time order of the CG transmission occasions in the CG configurations; and
determining the corresponding relationships between the CG transmission occasions and the first indication bits based on the order of the CG transmission occasions.

6-7. (canceled)

8. The method according to claim 2, wherein
the first parameter field is a two-dimensional bitmap, a number of the first indication bits comprised in the two-dimensional bitmap is L, L is greater than or equal to a product of N and M, N is a number of the CG configurations, M is a number of CG transmission occasions in a first CG configuration, and the first CG configuration is a CG configuration having a maximum number of CG transmission occasions among the N CG configurations,
the first message further comprises a second parameter field, and the second parameter field is configured to indicate the number M of the CG transmission occasions in the first CG configuration, and
determining the corresponding relationships between the CG transmission occasions and the first indication bits based on the order of the plurality of CG configurations comprises:
obtaining at least N sub-bitmaps by grouping the L first indication bits based on N, wherein a number of first indication bits comprised in each of the at least N sub-bitmaps is greater than or equal to M;
determining sub-bitmaps corresponding to the CG configurations based on the order of the plurality of CG configurations; and
determining the corresponding relationships between the CG transmission occasions and the first indication bits based on a time order of the CG transmission occasions in the CG configurations.

9-10. (canceled)

11. The method according to claim 8, wherein obtaining the at least N sub-bitmaps by grouping the L first indication bits based on N comprises one of:
obtaining first K first indication bits from the L first indication bits, wherein K is equal to the product of N and M; and evenly dividing the K first indication bits into N sub-bitmaps, wherein a number of first indication bits comprised in each of the N sub-bitmaps is equal to M;
or
evenly dividing the L first indication bits into N sub-bitmaps, wherein a number of first indication bits comprised in each of the N sub-bitmaps is greater than or equal to M.

12. (canceled)

13. The method according to claim 1, wherein at least one of:
a case where the first wireless resources are the CG configurations, the first parameter field comprises a plurality of second indication bits, and one of the plurality of second indication bits is configured to indicate a resource usage state of one of the CG configurations;
or
a case where the first message further comprises a third parameter field, and the third parameter field is configured to indicate a number of the CG configurations.

14. (canceled)

15. The method according to claim 1, wherein
in a case where the first message further comprises a fourth parameter field, the fourth parameter field is configured to indicate a second CG configuration, and the second CG configuration includes at least one of the plurality of CG configurations; wherein the fourth parameter field comprises at least one third indication bit, and the third indication bit is configured to indicate the second CG configuration; or the fourth parameter field comprises a configuration index corresponding to the second CG configuration; and
in a case where the first message does not comprise the fourth parameter field. the second CG configuration includes the plurality of CG configurations; or the second CG configuration is a CG configuration for sending the first message.

16-17. (canceled)

18. The method according to claim 1, wherein sending the first message to the network device comprises:
sending, via a third CG configuration, the first message to the network device, and the third CG configuration is one of:
a CG configuration determined based on agreement in a protocol, a CG configuration determined by the network device and sent to the terminal, or
a CG configuration determined by the terminal and sent to the network device; and
a resource usage state is an idle state or an occupied state.

19. (canceled)

20. A method for determining a resource state, performed by a network device, comprising:
receiving a first message sent by a terminal, wherein the first message comprises a first parameter field, the first parameter field is configured to indicate resource usage states of first wireless resources, and the first wireless resources are wireless resources allocated by the network device to the terminal based on a plurality of configured grant (CG) configurations; and
determining the resource usage states of the first wireless resources based on the first parameter field in the first message.

21. The method according to claim 20, wherein
the first wireless resources are CG transmission occasions,
the first parameter field comprises a plurality of first indication bits, and one of the plurality of first indication bits is configured to indicate a resource usage state of one of the CG transmission occasions, and
the method further comprises:
determining an order of the plurality of CG configurations; and
determining corresponding relationships between the CG transmission occasions and the first indication bits based on the order of the plurality of CG configurations.

22. (canceled)

23. The method according to claim 21, wherein determining the order of the plurality of CG configurations comprises:
determining the order of the plurality of CG configurations by sorting the plurality of CG configurations based on CG parameters of the CG configurations, and
a CG parameter of a CG configuration comprises at least one of:
a configuration index of the CG configuration;
frequency-domain position information of the CG configuration;
time-domain position information of the CG configuration;
a number of CG transmission occasions comprised in the CG configuration; or
a Priority of the CG configuration.

24. The method according to claim 21, wherein
the first parameter field is a one-dimensional bitmap,
a number of the first indication bits comprised in the one-dimensional bitmap is greater than or equal to a number of valid CG transmission occasions, and the number of the valid CG transmission occasions is a total number of valid CG transmission occasions comprised in the plurality of CG configurations,
the valid CG transmission occasions are configured to indicate CG transmission occasions comprised in a first time window in a time domain, and the first time window is one of: a duration agreed in a protocol, a duration determined by the network device and sent to the terminal, or a duration determined by the terminal and sent to the network device, and
determining the corresponding relationships between the CG transmission occasions and the first indication bits based on the order of the plurality of CG configurations comprises:
determining an order of the CG transmission occasions based on the order of the plurality of CG configurations and a time order of the CG transmission occasions in the CG configurations; and
determining the corresponding relationships between the CG transmission occasions and the first indication bits based on the order of the CG transmission occasions.

25-26. (canceled)

27. The method according to claim 21, wherein
the first parameter field is a two-dimensional bitmap, a number of the first indication bits comprised in the two-dimensional bitmap is L, L is greater than or equal to a product of N and M, N is a number of the CG configurations, M is a number of CG transmission occasions in a first CG configuration, and the first CG configuration is a CG configuration having a maximum number of CG transmission occasions among the N CG configurations,
the first message further comprises a second parameter field, and the second parameter field is configured to indicate the number M of the CG transmission occasions in the first CG configuration, and
determining the corresponding relationships between the CG transmission occasions and the first indication bits based on the order of the plurality of CG configurations comprises:
obtaining at least N sub-bitmaps by grouping the L first indication bits based on N, wherein a number of first indication bits comprised in each of the at least N sub-bitmaps is greater than or equal to M;
determining sub-bitmaps corresponding to the CG configurations based on the order of the plurality of CG configurations; and
determining the corresponding relationships between the CG transmission occasions and the first indication bits based on a time order of the CG transmission occasions in the CG configurations.

28-29. (canceled)

30. The method according to claim 27, wherein obtaining the at least N sub-bitmaps by grouping the L first indication bits based on to N comprises one of:
obtaining first K first indication bits from the L first indication bits, wherein K is equal to the product of N and M; and evenly dividing the K first indication bits into N sub-bitmaps, wherein a number of first indication bits comprised in each of the N sub-bitmaps is equal to M;
or
evenly dividing the L first indication bits into N sub-bitmaps, wherein a number of first indication bits comprised in each of the N sub-bitmaps is greater than or equal to M.

31. (canceled)

32. The method according to claim 20, wherein at least one of:
a case where the first wireless resources are the CG configurations, the first parameter field comprises a plurality of second indication bits, and one of the plurality of second indication bits is configured to indicate a resource usage state of one of the CG configurations;
or
a case where the first message further comprises a third parameter field, and the third parameter field is configured to indicate a number of the CG configurations.

33. (canceled)

34. The method according to claim 20, wherein
in a case where the first message further comprises a fourth parameter field, the fourth parameter field is configured to indicate a second CG configuration, and the second CG configuration includes at least one of the plurality of CG configurations; wherein the fourth parameter field comprises at least one third indication bit, and the third indication bit is configured to indicate the second CG configuration; or the fourth parameter field comprises a configuration index corresponding to the second CG configuration; and
in a case where the first message does not comprise the fourth parameter field, the second CG configuration includes the plurality of CG configurations; or the second CG configuration is a CG configuration for sending the first message.

35-36. (canceled)

37. The method according to claim 20, wherein receiving the first message sent by the terminal comprises:
receiving, via a third CG configuration, the first message sent by the terminal, wherein the third CG configuration is one of: a CG configuration determined based on agreement in a protocol, a CG configuration determined by the network device and sent to the terminal, or a CG configuration determined by the terminal and sent to the network device, and
a resource usage state is an idle state or an occupied state.

38-40. (canceled)

41. A device for determining a resource state, comprising:
a processor; and
a memory configured to store instructions executable by the processor, and
wherein the processor is configured to:
send a first message to a network device, wherein the first message comprises a first parameter field, the first parameter field is configured to indicate resource usage states of first wireless resources, and the first wireless resources are wireless resources corresponding to a plurality of configured grant (CG) configurations.

42-43. (canceled)

44. A device for determining a resource state, comprising:
a processor; and
a memory configured to store instructions executable by the processor; and
wherein the processor is configured to perform steps of the method according to claim 20.
